(19) United States
(12) Patent Application Publication
(10) Pub. No.: US 2020/0407212 A1
(43) Pub. Date: Dec. 31, 2020

(54) DETACHABLE SADDLE BAG BEVERAGE COOLER SYSTEM

(71) Applicants: Albert E. Williams, Belfast, TN (US); James Knox Blackburn, V, Franklin, TN (US)

(72) Inventors: Albert E. Williams, Belfast, TN (US); James Knox Blackburn, V, Franklin, TN (US)

(21) Appl. No.: 16/456,796

(22) Filed: Jun. 28, 2019

(51) Int. Cl. B68C 1/20; F25D 3/08

(52) U.S. Cl. CPC B68C 1/20; F25D 2331/801; F25D 3/08

(57) ABSTRACT

A saddle bag cooling system is provided. The saddle bag cooling system is for keeping contents retained therein cool, wherein the system embodies a center pad dimensioned and adapted so that when lain on a horseback a middle portion of the center pad is adjacent to and upward of a spine of the horseback, and the end portions are generally parallel to each other yet transverse relative to the middle portion. The center pad removably connects to a center bag and two coolers, each cooler adapted to retain a temperature less than the ambient air and removably connectable to one of two opposing end portions.

### BACKGROUND OF THE INVENTION

The present invention relates to saddle accessories and, more particularly, a removably attachable saddle bag system adapted for keeping contents cool.

It is difficult to ride and direct a horse while carrying an item, such as a beverage container, in one's hand. There are only so many beverages that can be packed for a trail ride, and coolers' bulky shape make it difficult to for coolers to attach to standard saddle bags. As a result, beverages are not only difficult to carry on horse trail rides, but also difficult to keep cold, making it difficult to preserve the coldness of one's drink on a trail ride.

As can be seen, there is a need for a removably attachable saddle bag cooling system adapted for keeping contents retained therein cool. The present invention provides a cooling system adapted to reduce the effort of manual exertion required in carrying a beverage, freeing up a rider's hands, and thereby allowing the rider to direct their horse and focus on the trail ride, all while keeping the beverage cold and portable inside the cooling system.

The saddle bag cooling system embodies coolers detachably attachable to a center pad, wherein the coolers provides a way to carry many containers during a trail ride, freeing up the rider's hands and keeping the containers cold for an extended period of time. The saddle bag cooling system may also include detachable storage bags, enabling riders to carry additional containers, which can be placed in the coolers along the riding trail.

### SUMMARY OF THE INVENTION

In one aspect of the present invention, a saddle bag cooling system for keeping contents retained therein cool includes the following: a center pad having top surface and an opposing bottom surface, wherein said center pad has a centrally disposed middle portion and two opposing end portions; wherein the center pad is dimensioned and adapted so that when lain on a horseback the middle portion is adjacent to and upward of a spine of said horseback, and the end portions are generally parallel to each other yet transverse relative to the middle portion; and two coolers, each cooler removably connected to one of two opposing end portions.

In another aspect of the present invention, a saddle bag cooling system for keeping contents retained therein cool includes the following: a center pad having top surface and an opposing bottom surface, wherein said center pad has a centrally disposed middle portion and two opposing end portions; wherein the center pad is dimensioned and adapted so that when lain on a horseback the middle portion is adjacent to and upward of a spine of said horseback, and the end portions are generally parallel to each other yet transverse relative to the middle portion; two coolers, each cooler removably connected to one of two opposing end portions; one or more cooler connectors provided along each end portion; one or more rear cooler connectors provided by each cooler, wherein the rear cooler connector removably attachable to the one or more cooler connectors, wherein each end and rear cooler connector is elongated and, wherein each end cooler connector is oriented transversely relative to each rear cooler connector; a center bag removably connected to the middle portion; one or more middle cooler connectors provided along the middle portion, wherein each middle cooler connector removably connects to an upper portion of each cooler; and a plurality of side connectors disposed along a periphery the center pad for connecting to a saddle mounted to said horseback.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in use;

FIG. 2 is a perspective view of an exemplary embodiment of the present invention;

FIG. 3 is an exploded perspective view of an exemplary embodiment of the present invention, shown in use;

FIG. 4 is a section view of an exemplary embodiment of the present invention, taken along line 4-4 n FIG. 2;

FIG. 5 is a perspective view of an exemplary embodiment of a cooler 10 of the present invention in an open condition, the cooler 10 is shown removed from center pad 50; and

FIG. 6 is a perspective view of an exemplary embodiment of cooler 10 in an attached condition of the present invention, the cooler 10 shown removed from the center pad 50.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a saddle bag cooling system for keeping contents retained therein cool, wherein the system embodies a center pad dimensioned and adapted so that when lain on a horseback a middle portion is adjacent to and upward of a spine of said horseback, and the end portions are generally parallel yet transverse relative to the middle portion. The center pad removably connects to a center bag and two coolers, each cooler adapted to retain a temperature less than the ambient air and be removably connectable to one of two opposing end portions.

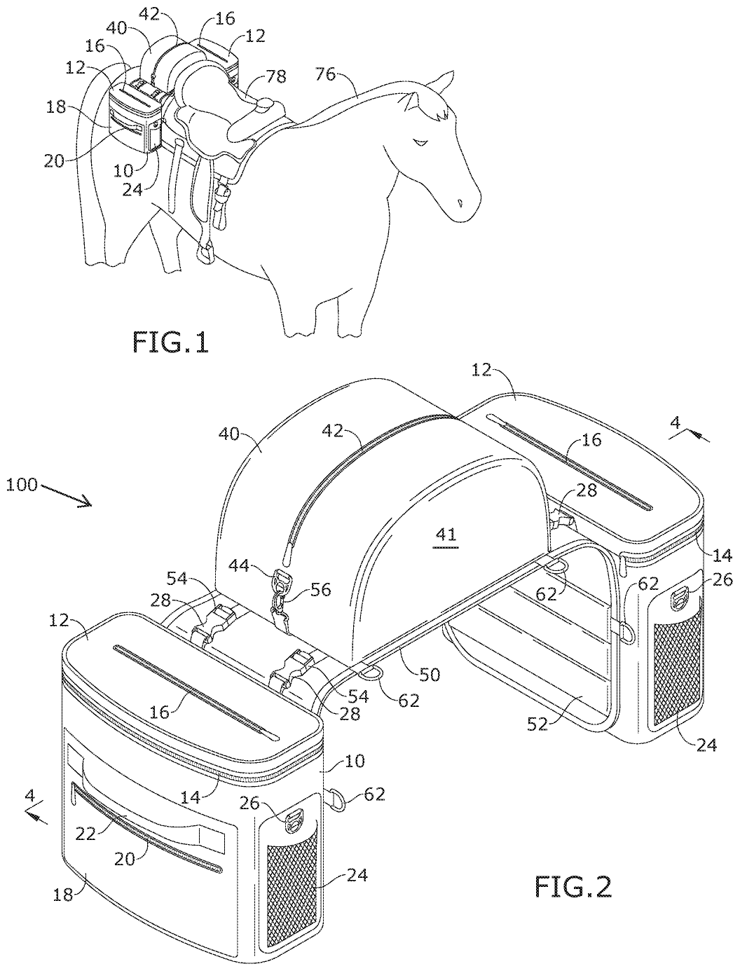

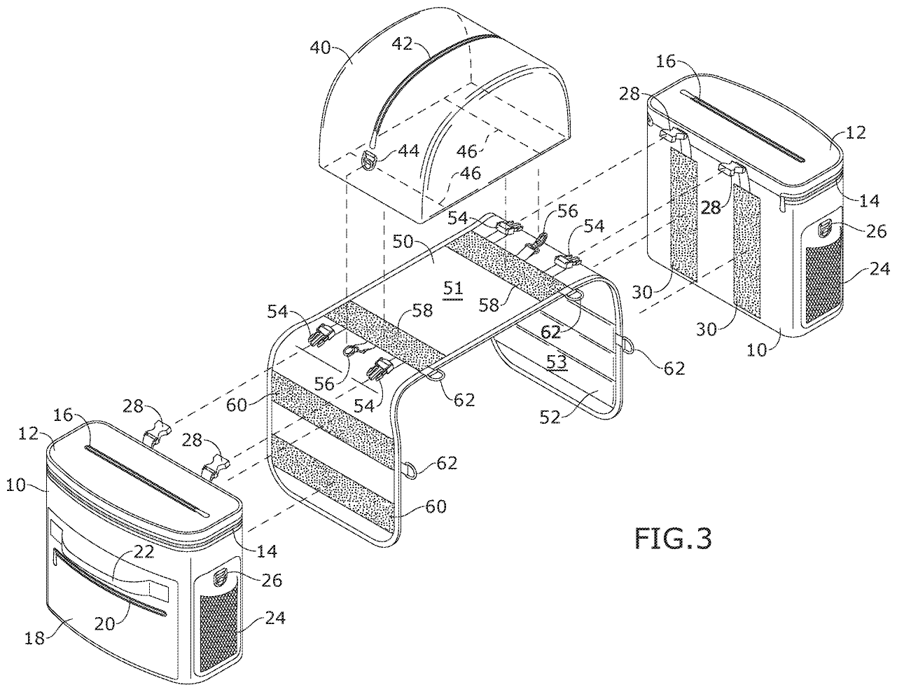

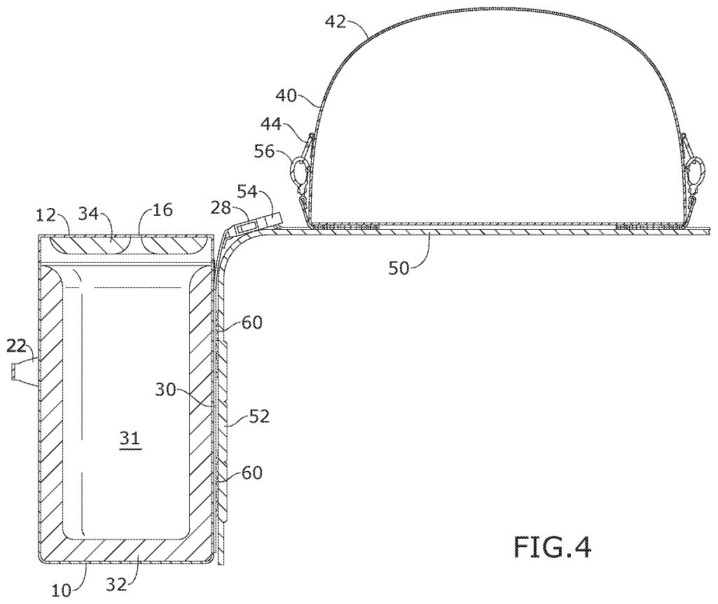

Referring now to FIGS. 1 through 6, the present invention may provide a saddle bag cooling system 100. At its base, the saddle bag cooling system 100 may include a center pad 50 dimensioned and adapted lay over horseback of a horse 76, adjacent to a saddle 78. The center pad 50 is adapted to removably associate with a center bag 40 and one or more coolers 10, one cooler 10 on each of the two opposing ends of the center pad 50.

The center bag 40 may have a plurality of sidewalls 41, such as fabric reinforced vinyl, defining a bag enclosure 31 for storing contents. A detachable fastener 42 is movable between a stored condition and an accessible condition for accessing the enclosure. The center bag 40 may provide first and second bag connectors 44 and 46 adapted to engage first and second pad connectors 58 and 56, respectively, removably securing the center bags 40 and the center pad 50. The first bag and pad connectors 44 and 56 may be an attachment ring and a removably connectable hook 56, respectively. The second bag and pad connectors 46 and 58 may be hook and loop fasteners, respectively.

It should be understood by those skilled in the art that the use of directional terms such as upper, lower, upward, downwardly, top and the like are used in relation to the illustrative embodiments as they are depicted in the figures, the upward direction (or upper) being toward the top of the corresponding figures and a downward direction being toward the bottom of the corresponding figures.

The center pad 50 may also provide top surface and an opposing bottom surface. Said center pad 50 surfaces may have a centrally disposed middle portion 51 and opposing end portions 53. The center pad 50 may be dimensioned so that when lain on horseback the top surface of the middle portion 51 is adjacent to and upward facing from the spine of the horse 76, while the bottom surface of the end portions 53 are facing each other, both orthogonal relative to the middle portion 51. The top surface may provide middle cooler connectors 54 adapted to removably connect to a top cooler connector 28 so that the cooler 10 is removably connected to the center pad 50. Each cooler 10 may have a plurality of sidewalls, such as fabric reinforced vinyl, defining a cooler enclosure 31 for cooling its contents. The cooler enclosure 31 may be lined with thermal insulating material 32 and 34, such as high-density foam. A lid 12 may be pivotably attached along a periphery of the opening communicating to the cooler enclosure 31, so that the lid 12 moves between an open position and a closed position. A lid detachable fastener 16 may be provided along the remainder of the periphery for securing the lid 12 in a locked engagement when in the closed position. The lid 12 may also provide a top detachable fastener 14 for gaining access to the cooler enclosure 31 via the top of the lid 12. The center pad 50 may have side connectors 62, such as D-rings, disposed along the periphery thereof for connected to the saddle 78.

The center pad 50 may provide end cooler connectors 60 adjacent to or near its opposing ends. Each cooler 10 may provide rear cooler connectors 30 adapted to removably connect to the end cooler connectors 60. The end cooler connectors 60 may be oriented orthogonally relative to the rear cooler connectors 30. Each end cooler connectors 60 may provide under-sided padded strips 52 along the bottom surface of the center pad 50, along the end portions 53.

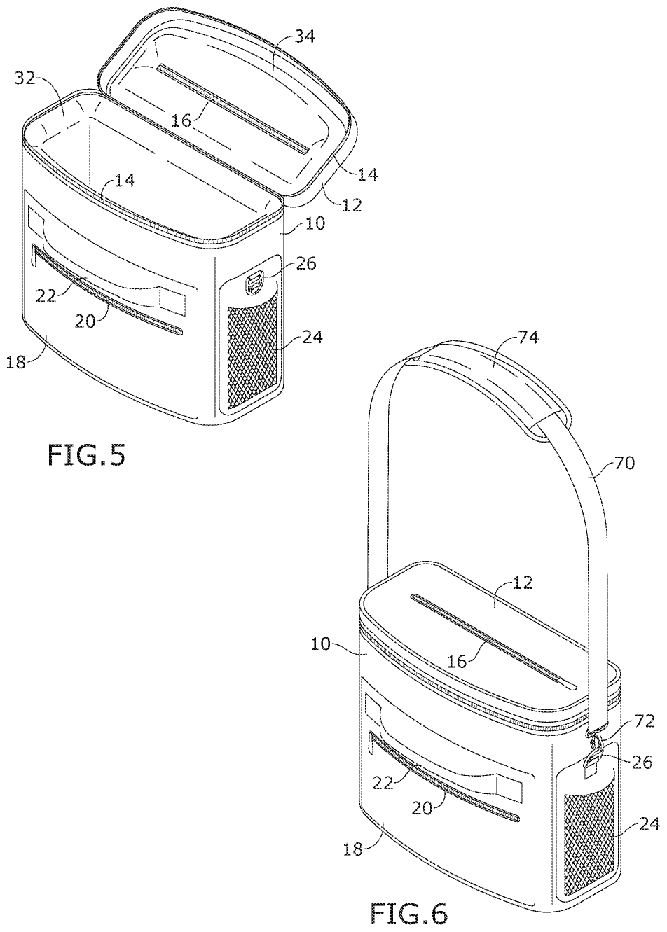

Referring to FIGS. 5 and 6, each cooler 10 may have front and side pockets 18 and 24 for removably retaining non-cooled contents. Each cooler 10 may provide a handle 22 for manually carrying the cooler 10. Additionally, each cooler 10 may provide two opposing strap attachment points 26, such as rings, for removably connecting a strap 70 via strap hooks 72 for toting the cooler 10 over one's shoulder. The strap 70 may include a strap pad 74 as well.

A method of using the present invention may include the following. The saddle bag cooling system 100 disclosed above may be provided. A user may place contents, such as beverage containers, that need to maintain a temperature different than that ambient temperature, in one of the cooler enclosures 31. Then the user may attach one or both coolers 10 to the center pad 50 that is already lain on the horseback. The saddle bag cooling system 100 is typically prepared before the trail ride by adding desired beverages inside the coolers 10, while accessories that are needed for the intended trip may be placed in the bag enclosure 31 of the center bag 40. Then the coolers 10 and center bag 40 are removably attached to the center pad 50, which is laying on the horse 76. Thereby the user is enabled to carry more objects than what they could otherwise carry with two hands, and those content in need of remaining cool would be so maintained. Additionally, via the bag enclosure 31 and/or the have front and side pockets 18 and 24, non-cooled content may be toted around by the horse 76 so that when the cooled containers within the coolers 10 start to get depleted, the non-cooled contents are replacements, soon to be sufficient cooler for subsequent use,

It should be understood, of course, that the foregoing relates to exemplary embodiments of the invention and that modifications may be made without departing from the spirit and scope of the invention as set forth in the following claims.

What is claimed is:

1. A saddle bag cooling system for keeping contents retained therein cool, comprising:
a center pad having a centrally disposed middle portion and two opposing end portions;
wherein the center pad is dimensioned and adapted so that when lain on a horseback the middle portion is adjacent to and upward of a spine of said horseback, and the end portions are generally parallel to each other yet transverse relative to the middle portion; and
two coolers, each cooler removably connected to one of two opposing end portions.

2. The saddle bag cooling system for keeping contents retained therein cool of claim 1, further comprising:
one or more cooler connectors provided along each end portion; and
one or more rear cooler connectors provided by each cooler, wherein the rear cooler connector removably attachable to the one or more cooler connectors.

3. The saddle bag cooling system for keeping contents retained therein cool of claim 2, wherein each end and rear cooler connector is elongated and, wherein each end cooler connector is oriented transversely relative to each rear cooler connector.

4. The saddle bag cooling system for keeping contents retained therein cool of claim 1, further comprising a center bag removably connected to the middle portion.

5. The saddle bag cooling system for keeping contents retained therein cool of claim 1, further comprising one or more middle cooler connectors provided along the middle portion, wherein each middle cooler connector removably connects to an upper portion of each cooler.

6. The saddle bag cooling system for keeping contents retained therein cool of claim 1, further comprising a plurality of side connectors disposed along a periphery the center pad for connecting to a saddle mounted to said horseback.

7. A saddle bag cooling system for keeping contents retained therein cool, comprising:
a center pad having a centrally disposed middle portion and two opposing end portions;
wherein the center pad is dimensioned and adapted so that when lain on a horseback the middle portion is adjacent to and upward of a spine of said horseback, and the end portions are generally parallel to each other yet transverse relative to the middle portion;
two coolers, each cooler removably connected to one of two opposing end portions;
one or more cooler connectors provided along each end portion;
one or more rear cooler connectors provided by each cooler, wherein the rear cooler connector removably attachable to the one or more cooler connectors, wherein each end and rear cooler connector is elongated and, wherein each end cooler connector is oriented transversely relative to each rear cooler connector;
a center bag removably connected to the middle portion;
one or more middle cooler connectors provided along the middle portion, wherein each middle cooler connector removably connects to an upper portion of each cooler; and
a plurality of side connectors disposed along a periphery the center pad for connecting to a saddle mounted to said horseback.
